(19) United States
(12) Patent Application Publication
(10) Pub. No.: US 2021/0182952 A1
(43) Pub. Date: Jun. 17, 2021

(54) ELECTRONIC PLATFORM FOR AUCTION

(71) Applicants: Sezai Sablak, East Stroudsburg, PA (US); Mustafa Sencan, Bethlehem, PA (US)

(72) Inventors: Sezai Sablak, East Stroudsburg, PA (US); Mustafa Sencan, Bethlehem, PA (US)

(21) Appl. No.: 17/189,172

(22) Filed: Mar. 1, 2021

Related U.S. Application Data
(60) Provisional application No. 63/136,065, filed on Jan. 11, 2021.

(51) Int. Cl. G06Q 30/08; G06Q 30/06

(52) U.S. Cl. CPC G06Q 30/08; G06Q 30/0643; G06Q 30/0619

(57) ABSTRACT

An electronic platform for auctioning of goods or services includes an interface module, a registration module, an auction module, and a settlement module. The registration module registers a seller for hosting an auction and buyers for participating in the auction. The auction module receives details of good or service to be auctioned from a seller interface, advertise listing of the auction, receive biddings from a buyer interface, and receive a winning bid. The settlement module receives an inconvenience deposit from the seller and a winning buyer and deposits the inconvenience deposit in an escrow account. The settlement module can initiate settlement of the sale of the good or service auctioned and forfeit the inconvenience deposit of the seller or buyer who defaults in the settlement.

### FIELD OF INVENTION

The present invention relates to an electronic platform for auction, and more particularly the present invention relates to an electronic platform for bidding in an auction and making a settlement between a seller and a buyer in the auction.

### BACKGROUND

Auction is a well-known business process for a public sale of goods or services by offering them up for bid. Goods or services can be sold to the highest bidder. The auction can be both physical and electronic. In the physical auction, the potential buyers collect at a place for the auction, where the goods or services are presented to the potential buyers. In electronic auctions, also known as e-auctions, the goods are displayed online and bids are also received online.

Auctions are a good means for valuation of goods, in particular old goods, and getting best selling prices, however, known auction methods suffer from one or more major drawbacks. First, the known auction methods are general, and not specific for any goods. So, the auction typically lacks good exhibition and details about the product. Second, either the seller or buyer may not show up at the time of settlement, or refuses the settlement, which discourages the auctioning.

There currently exists a long-term need for a platform that can overcome the said drawbacks of convention auctioning methods.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to an electronic platform for auctions that can be customized for specific goods.

It is another object of the present invention that the electronic platform can be customized for auctioning the cars.

It is still another object of the present invention that the electronic platform is user friendly.

It is yet another object of the present invention that the electronic platform is cost-effective.

It is an additional object of the present invention that the electronic platform upholds the trust of the buyer and the seller.

It is a further object of the present invention that the electronic platform can be used for both personal and commercial goods and services.

In one aspect, the disclosed electronic platform may comprise an interface module, a registration module, an auction module, and a settlement module.

In one aspect, the interface module may provide a buyer interface and a seller interface. The buyer interface can be displayed on a buyer device and allows the buyer to interact with the disclosed electronic platform. Similarly, the seller interface can be presented on the seller device for interacting with the disclosed electronic platform.

In one aspect, the registration module may allow a buyer and seller to register to the disclosed electronic platform. Also, the registration module may allow a seller to register for hosting an auction on the disclosed electronic platform. The registration module may also allow buyers to register for bidding in the auction. The registration module may also provide for receiving a service fee from the registered seller and the registered buyers.

In one aspect, the auction module may allow the seller to host the auction and the buyers to participate and bid in the auction. The auction module may also provide for receiving a final bid and concluding the auction.

In one case, the settlement module may allow for settlement between a seller and the final bidder (winning bid).

These and other objects and advantages of the embodiments herein will become readily apparent from the following detailed description taken in conjunction with the accompanying drawings.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is an environmental diagram showing the disclosed electronic platform in communication with a seller device and multiple buyer devices, according to an exemplary embodiment of the present invention.

FIG. 2 is a flow chart showing an exemplary embodiment of the registration module, according to an exemplary embodiment of the present invention.

FIG. 3 is a flow chart showing an exemplary embodiment of the auction module, according to an exemplary embodiment of the present invention.

FIG. 4 shows an exemplary embodiment of a buyer interface showing a listing of an auction, according to an exemplary embodiment of the present invention.

FIG. 5 is a flow chart showing the settlement module, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

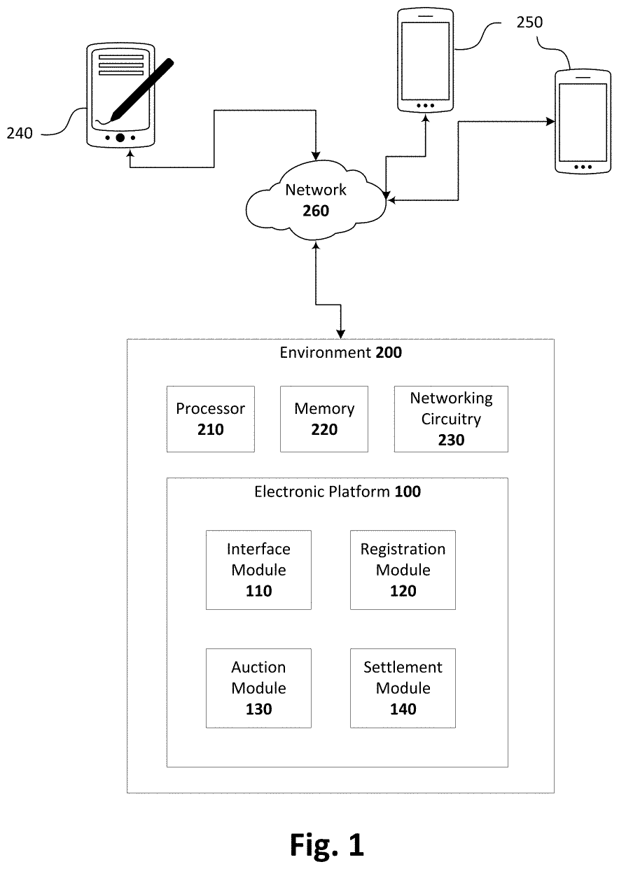

Disclosed is an electronic platform for auctioning cars and in particular used cars. Referring to FIG. 1, which shows an exemplary embodiment of the electronic platform 100 in a hardware environment 200 having one or more processors 210, a memory 220 operably coupled to the one or more processors 210, and a networking circuitry 230. The disclosed electronic platform 100 can be executed in the environment 200 for auctioning automobiles, including cars. FIG. 1 also shows the electronic platform 100 is communicating with a seller device 240 and multiple buyer devices 250. The seller device and the buyer devices can connect with the electronic platform 100 through a network 260. Environment 200 can have a networking circuitry 230 for connecting to network 260.

Network 260 can be wired or wireless. Wired networks may include Digital Subscriber Line (DSL), coaxial cable lines, or optical fiber lines. The wireless networks may include BLUETOOTH, Wi-Fi, Worldwide Interoperability for Microwave Access (WiMAX), an infrared channel or satellite band, cellular networks such as 2G, 3G, or 4G. It is to be understood that FIG. 1 shows a single network 260 connecting the buyer device and the seller device to the disclosed electronic platform 100, however, those skilled in the art will recognize that the buyer device and the seller device can connect to the electronic platform through different networks which may be wireless or wireless. Also, the multiple buyer devices can connect to the electronic platform 100 using different networks. Those skilled in the art will also recognize that a device can connect to another device using interconnected networks which may be wired, wireless, or combinations thereof.

The seller device or the buyer device can include or is embodied by or included in a smartphone, tablet computing device, personal digital assistant (PDA), desktop computer, workstation, or the like, and may be configured to operate as a fat client, thin client, or zero-footprint client.

Referring to FIG. 1, the electronic platform 100 can include an interface module 110, a registration module 120, an auction module 130, and a settlement module 140. The interface module 110 facilitates the sellers and buyers to interact with the disclosed electronic platform 100. The interface module can provide a buyer interface on a buyer device and a seller interface on a seller device. The interface can be provided as an application software on the buyer and seller devices. In one case, the application software can be downloaded from an application distribution platform, such as App Store, GOOGLE PLAY, Chrome Webstore, and Amazon Appstore. Alternatively, the interface can also be provided through world-wide-web and accessible on the seller and buyer devices through a browser, such as Chrome.

The registration module can allow a seller to register with the electronic platform for selling automobiles, such as a car. The seller can provide their basic details, such as name and contact details. A mobile number and/or email may be required to send the notifications. The registration module may allow temporary registration or membership registration. A temporary registration may allow a seller to host a single auction. Alternatively, a seller can subscribe to a membership, which may be for a fixed duration, such as one year or a lifetime. With membership, the seller can host multiple auctions by registering one time. The registration module may also provide for verifying the sellers, such as receiving a dealer certificate from a dealer for verification. Such sellers can be tagged as certified dealers in the electronic platform. Certified dealers can be different from individual sellers which may require prior approval before auctioning. Also, the dealers may only be eligible for the memberships. The membership can provide additional benefits, such as lower service fees.

Buyers may access a buyer interface that shows the available auctions without registration. Users can navigate, through the buyer interface, on the buyer devices, a list of auctions with details, such as timings. A buyer can register for the desired action from the list of available auctions. The buyer can provide basic details, such as name and contact details. The buyer can provide a contact number and/or email id for receiving the notifications. The registration module may also receive a service fee from the registered seller for auctioning and buyers for bidding in the auction. The buyer registering for participating in an auction can deposit a fee, such as 1 USD. Alternatively, the service fee can be received by the auction module.

The auction module may permit a seller to exhibit a car and receive bids from the participant buyers. The auction module 130 may allow a seller to upload a video, photographs, technical details, location of the automobile, any other information that may help a buyer to reach a buy decision. Although only one video may be allowed, photographs of multiple views can be uploaded through the seller interface. The seller can also provide the date and timings for the auction. The seller may also provide a starting bid value, which can be displayed in the auction. The seller may get a link to the auction, through which a buyer can register for the auction.

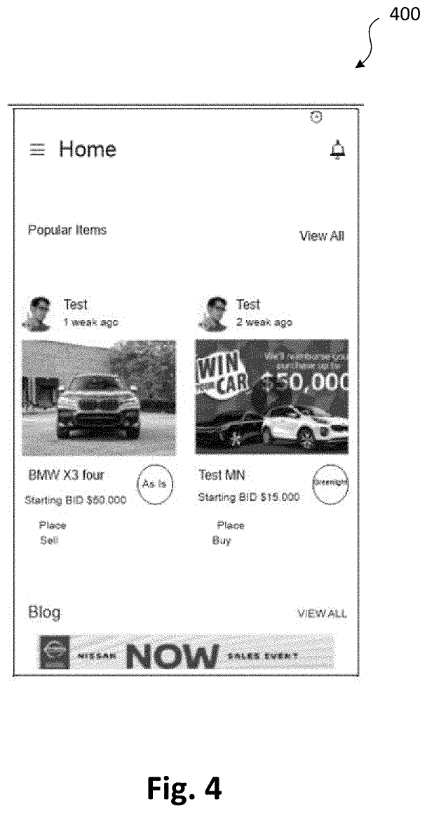

The auction module also allows a seller to advertise the listing of the auction. The auction can be listed, wherein the potential buyers can navigate through the listings on the buyer interface. The disclosed electronic platform can charge a predefined fee for hosting each auction. Additionally, charges may also be collected for advertisement. For example, advertisement campaigns can be made by the sellers, wherein notifications can be sent to the public in general that may be interested in the buy. FIG. 4 shows an exemplary embodiment of a listing 400 as displayed on a buyer interface.

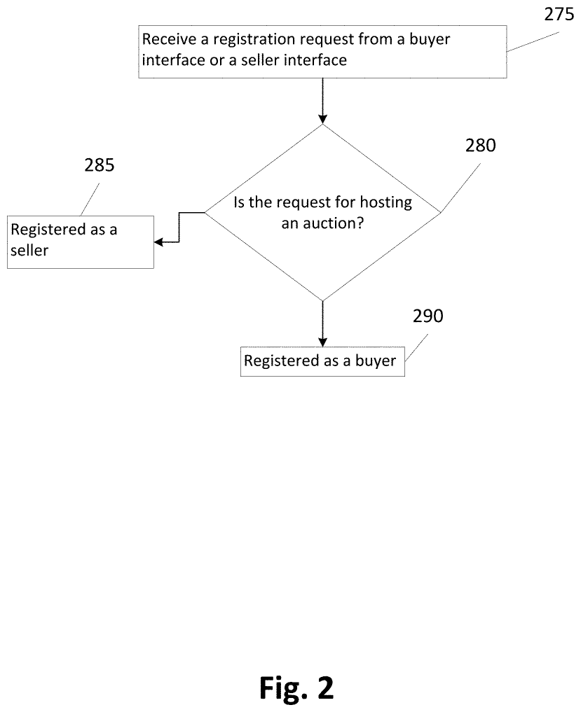

Referring to FIG. 2 which shows an exemplary embodiment of the registration module 120. At step 275, the registration module can receive registration requests through a buyer interface or a seller interface both provided by interface module 110. The registration module 120, at step 280, checks if the request is for hosting an auction. If the request is hosting an auction, then the user is registered as the seller, at step 285. Otherwise, the request would be for participating in an auction as a buyer, and the user can be registered as the buyer with the disclosed electronic platform, at step 290. The registration module may also permit collecting service fees from the registered seller and the buyers. Alternatively, the service fee can be collected by the auction module.

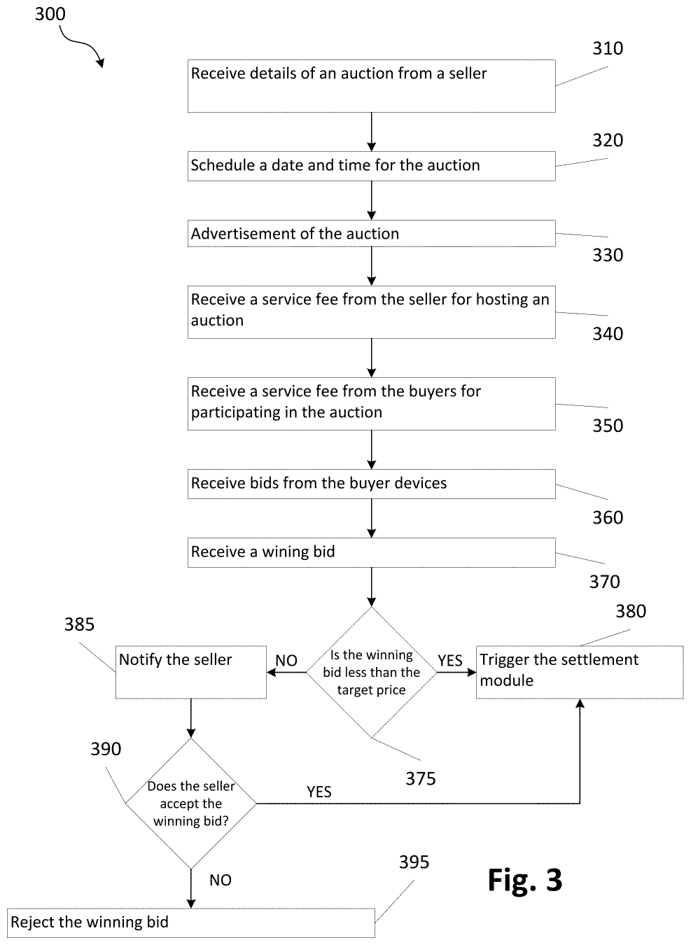

Referring to FIG. 3 is a flow chart 300 showing an exemplary embodiment of the auction module 130. The auction module may allow a seller to create a listing for an auction, for example auctioning an old car by providing details of the car and auction, at step 310. The seller interface can permit a seller to provide a title to the listing, multiple views of the car, and a video of the car. The auction module can also receive details of the auction like date, time, and starting Bid value. The seller can select the date and time for the auction. Additionally, other details like the technical specification can also be uploaded by the seller. The seller can be provided with template forms to provide the technical and compliance details for the car. The seller can also provide the target price of the auction and the duration of the auction. Alternatively, the duration of the auction can be default set by the auction module. The auction module can then schedule the auction on the given date and time, at step 320. The seller can change the scheduled date and time up to one day before the scheduled date. The seller can also advertise the listing of the auction, at step 330. The auction module, if not received by the registration module, can receive a service fee from a seller for hosting the auction, at step 340. The fee may not be collected from the subscribed members. The auction module may also collect service fee for advertisement. The auction module may also collect a service fee from each buyer registered for the auction, at step 350. The seller and buyer can be provided an option to pay the fee at the time of registration, before the auction, or any time between the two events.

The buyers can navigate the listed auctions on the buyer interface. An embodiment of the listing is shown in FIG. 4. The listing can show photographs, a video, and other details. Also, can be seen in the listing are icons “As Is” and “Green” which show the status of the car. Starting bid value and place are also visible in the listing. The auction module may also allow third-party inspection of the vehicle, and the inspection report may also be associated with the listing of the auction. The auction module can start the auction on the scheduled date and time. The buyers can place bids through the buyer interface, at step 360. The buyer interface can show the bidding start value, last bidding amount, and the name of the bidder. The buyer interface can also show the remaining time for the auction to end. Denominations, such as $100, $200$, $300, $400, and $500 can be presented to the bidder on the buyer interface. To bid, a user can select the denomination, for example, the denominations can be presented as clickable icons. The bidder can select one of the denominations and confirm the bid, for example, clicking another icon “Pace Bid”. The buyer can receive notifications about the bidding and when their bids are surpassed. The seller on the seller interface may also see the auctioning including the bid values. The seller may also receive notifications about the bidding. The notifications can be push notifications through the interface module. The notifications may also be sent through other means, such as SMS, email, and like selected by the buyer and seller.

The auction cannot be ended by the seller before the scheduled end time and neither the end time can be changed by the seller. However, just before the end time, if a large number of biddings are being placed, the electronic platform may incrementally increase the end time of the auction by seconds or minutes. The last bid at the end of the auction can be considered as the winning bid and the auction can be concluded, at step 370.

A check can be made at step 380 if the last winning bid reaches or surpasses the pre-set target price by the seller. In case, the outcome of the check at step 375 is positive, the settlement module can be triggered, at step 380. However, if the winning bid is unable to reach the target price, the seller can be notified and given a pre-set time to either accept or reject the bid, at step 385. For example, the seller may have two hours from the notification time to either accept or reject the winning bid. The seller can confirm the same through the seller interface. If no response is received from the seller, the default decision can be made by the electronic platform, such as to accept the winning bid or reject the winning bid. If the seller accepts the winning bid, the settlement module may be triggered, at step 380. Otherwise, the winning bid is rejected, at step 395.

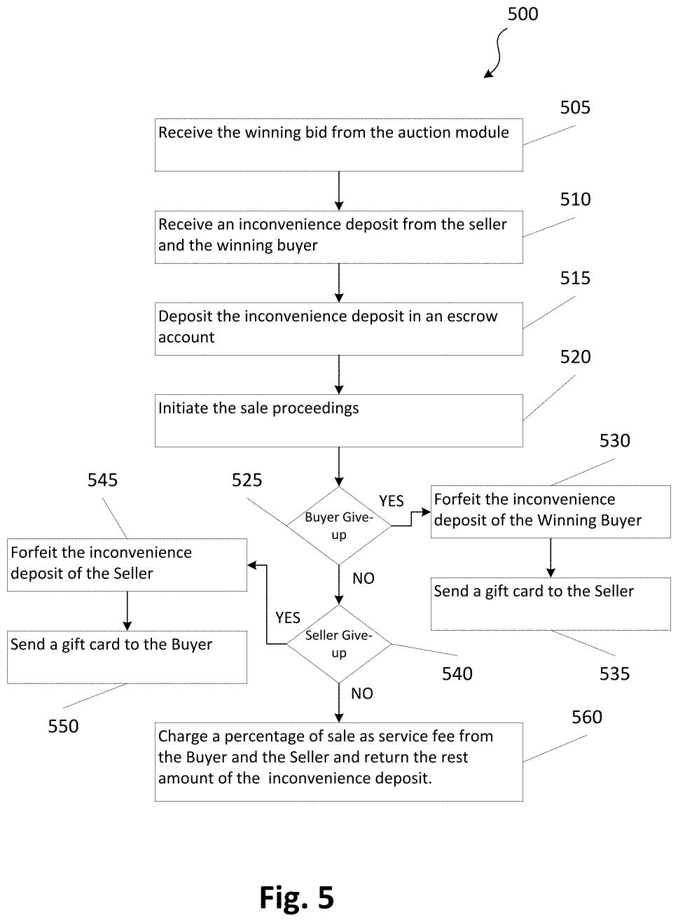

FIG. 5 is a flow chart 500 showing an exemplary embodiment of the settlement module 140. The settlement module may receive the winning bid from the auction module, at step 505. The settlement module may charge both the seller and the winning buyer, an inconvenience deposit, at step 510. For example, the settlement module may charge a predefined percentage of the winning bid value or the target price value as the inconvenience deposit. Alternatively, a fixed fee can also be charged, or whichever is higher. The inconvenience deposit from both the seller and the winning buyer can be deposit in an escrow account, at step 515. The settlement module may be connected to a registry or other means to know the status of sale, at step 520. If the buyer give-up from the sale, at step 525, the inconvenience deposit of the buyer can be forfeited by the settlement module, at step 530. Additionally, a gift card can be sent to the seller, at step 535. If the buyer does not give up, at step 525 but the seller give-up at step 540, the inconvenience deposit of the seller can be forfeited by the settlement module, at step 545. Additionally, a gift card can be sent to the winning buyer, at step 550. If the seller agrees to the sale, at step 530, the settlement can be finalized by the settlement module, ats step 560. The settlement module may charge a predefined service fee and return the remaining inconvenience deposit to the seller and the winning buyer.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed

What is claimed is:

1. An electronic platform which on execution by a processor facilitates auctioning of goods or services, the electronic platform comprises:
a registration module, upon execution by the processor, registers a seller for hosting an auction and buyers for participating in the auction;
an auction module, upon execution by the processor, receives details of goods or services to be auctioned from a seller interface, advertise listing of the auction, receive biddings from a buyer interface, and receive a winning bid; and
a settlement module, upon execution by the processor, receives an inconvenience deposit from the seller and a winning buyer, deposit the inconvenience deposit in an escrow account, initiate settlement of the sale of the good or service auctioned, and forfeit the inconvenience deposit of the seller or buyer who defaults in the settlement.

2. The electronic platform according to claim 1, wherein the electronic platform further comprises an interface module, which upon execution by the processor, provides the buyer interface and the seller interface.

3. The electronic platform according to claim 2, wherein the buyer interface shows the listing of the auction.

4. The electronic platform according to claim 3, wherein the buyer interface shows the starting bid valve, last bid value, a plurality of denomination values in the form of clickable icons, the buyer interface permits activating one of the pluralities of denomination values.

5. The electronic platform according to claim 3, wherein the auction module receives one of the pluralities of denomination values from the buyer interface and adds one of the pluralities of denomination values to the last bid value.

6. The electronic platform according to claim 2, wherein the auction module further sends notifications to the seller and the buyers through the seller interface and the buyer interface, wherein the notifications are related to the bidding.

7. A method for auctioning of goods or services, the method comprising the step of:
registering, by an electronic platform, a seller for hosting an auction and buyers for participating in the auction;
receiving, by the electronic platform, from a seller interface, details of goods or services to be auctioning;
scheduling and listing the auction, by the electronic platform;
receiving, by the electronic platform, from a buyer interface, biddings, and a winning bid;
receiving, by the electronic platform, from the seller and a winning buyer, an inconvenience deposit;
initiating, by the electronic platform, a settlement of the sale of the good or service auctioned; and
forfeiting, by the electronic platform, the inconvenience deposit of the seller or buyer who defaults in the settlement.

8. The method according to claim 7, wherein the method further comprises the step of:
providing, by the electronic platform, the buyer interface for the buyers and the seller interface for the seller.

9. The method according to claim 8, wherein the buyer interface shows the listing of the auction.

10. The method according to claim 9, wherein the buyer interface shows a starting bid valve, a last bid value, a plurality of denomination values in the form of clickable icons, the buyer interface permits activating one of the pluralities of denomination values.

11. The method according to claim 10, wherein the method further comprises the steps of:
receiving, by the electronic platform, one of the pluralities of denomination values from the buyer interface and add the one of the pluralities of denomination values to the last bid value.

12. The method according to claim 10, wherein the method further comprises the steps of:
sending, by the electronic platform, notifications to the seller and the buyers through the seller interface and the buyer interface, wherein the notifications are related to the bidding.
